(19) United States
(12) Patent Application Publication
(10) Pub. No.: US 2025/0378691 A1
(43) Pub. Date: Dec. 11, 2025

(54) PROCESSING IMAGE DATA OF SPECTATOR STANDS TO IDENTIFY AN AREA OF ATTENTION

(71) Applicant: Orange, Issy-les-Moulineaux (FR)

(72) Inventors: Stéphane COUTANT, CHATILLON CEDEX (FR); Julien CUMIN, CHATILLON CEDEX (FR)

(21) Appl. No.: 19/234,067

(22) Filed: Jun. 10, 2025

(30) Foreign Application Priority Data
Jun. 11, 2024 (FR) FR2406192

(51) Int. Cl. G06V 20/52; G06T 7/73; G06V 10/70; G06V 20/40; G06V 40/16; H04N 23/611; H04N 23/69

(52) U.S. Cl. CPC G06V 20/53; G06T 7/74; G06V 10/768; G06V 20/42; G06V 40/161; H04N 23/611; H04N 23/69; G06T 2207/30196; G06T 2207/30221; G06T 2207/30232

(57) ABSTRACT

A method of processing image data is proposed for a space where spectators are gathered, for example in a stand of a stadium. The processing includes: estimating, in a current neighborhood of spectators in the image, the respective head orientations of spectators in the neighborhood; and detecting, at least on the basis of the estimated head orientations, whether the heads are oriented towards an area of the space, in order to generate, if appropriate, a signal including data concerning the area as an area of attention for spectators in the space.

### CROSS-REFERENCE TO RELATED APPLICATIONS

This application claims foreign priority to FR2406192, filed Jun. 11, 2024. The contents of the priority application are incorporated by reference herein in its entirety.

### BACKGROUND

### Field

This disclosure relates to the processing of image data, in particular image data concerning stands of spectators attending an event, for example a sporting event.

One possible but non-limiting application is in monitoring spectator stands, in particular for safety reasons.

### Description of the Related Technology

Typically, very large gatherings of people present an increasingly acute safety challenge. The world of sports regularly faces this exact concern. France is addressing this challenge as it hosts the 2024 Summer Olympics.

Stadiums offer numerous advantages for managing spectator safety, because the arrangement of spectators in seats presents far fewer risks than a moving crowd where there is a chance of the crowd stampeding. In particular, it is important to detect any incident as early as possible, including in the stands of a stadium with seated spectators, because if the incident is not detected and addressed quickly, it can escalate into an uncontrolled crowd phenomenon.

Crowd safety management solutions exist, in particular through video analysis, for example capturing crowd density, speed (of a procession), and local movements of groups of people. Thus, for crowd monitoring, particularly a moving crowd, one primary indicator of an incident is specifically an abnormal movement of groups of people.

Conversely, in a stadium or concert hall with seating, detecting the beginnings of incidents on the basis of “movements” is not applicable.

The safety of seated spectators (and not moving or moving only slightly) is a complex task in a large stadium. There is no known technique other than manual: an operator uses a motorized camera to scan the crowd and, in case of doubt, he or she can point the camera's axis in a chosen direction and zoom into an area of interest.

Response time to an incident is crucial. In addition, the time until detection is important, and an automated process is sought.

Computer vision and artificial intelligence algorithms have recently made advances. Pre-trained models can already detect over a thousand common object types in an image, in particular human faces as an example.

However, alerting of an incident by the detection of an abnormal situation is more complex to formulate for a machine learning algorithm which specifically requires being fed a substantial set of examples.

It is therefore very complex to create a preliminary formulation of many threatening situations.

### SUMMARY

The present disclosure improves the situation.

A method is proposed for processing image data concerning a space where spectators are gathered, the method comprising:
estimating, in a current neighborhood of spectators in the image, the respective head orientations of spectators in said neighborhood,
detecting, at least on the basis of said estimated head orientations, whether said heads are oriented towards an area in the space, in order to generate, if appropriate, a signal comprising data concerning said area as an area of attention for spectators in said space.

Thus, according to the proposed approach, the aim is to “capture”, in real time, the collective intelligence of a group of people who can react to any type of abnormal situation. Thus, in this approach, the spectators themselves contain the relevant information to be identified. For example, if the attention of a significant number of people is drawn to a same area in a space where spectators are gathered, then this area most likely presents a noteworthy situation which merits a more detailed analysis, particularly if it involves an incident requiring a response.

In addition to the increased reliability due to collective intelligence (a group of spectators in a neighborhood), this approach also has the advantage of focusing efforts on simply detecting human faces (or “heads” hereinafter) of spectators and the orientations of these heads.

The aforementioned space “where spectators are gathered” may typically be a spectator stand, for example in a stadium, a concert hall, a theater, or some other venue.

Thus, if a significant number of gazes converge on the same area in this space, then this area is of particular interest, or, for example, has a potential incident.

In one embodiment, the aforementioned signal may comprise geographic coordinate data for the detected area of attention. Typically, if the image is captured by a mobile camera, the geographic coordinates may be deduced from the current settings of the mobile camera.

In this case, law enforcement officers may be alerted by this signal, and, using the geographic coordinates, can go to the location to verify whether there is indeed an imminent danger.

Alternatively, the aforementioned signal may be transmitted to a monitoring camera in order to zoom into this area of attention (the camera being, for example, connected to a monitoring center, for rapid intervention for example).

Alternatively, a digital zoom may be performed on the same image captured by the first camera, into the detected area of attention, and the zoomed image may be transmitted to a monitoring center or to a control room for insertion of this zoomed image into a television stream, or sent elsewhere for some other use.

In one embodiment, for each spectator in the neighborhood associated with an area that is a candidate as an area of attention (“candidate area”), an angular deviation is estimated between:
a straight line passing through the spectator's head and the candidate area, and
a head orientation of the spectator.

The more the spectator's head is oriented towards the aforementioned candidate area, the smaller the absolute value of this angular deviation.

In this embodiment, an average representative of the angular deviations may be estimated over all spectators in the neighborhood, for the aforementioned candidate area, and the estimated average may be compared to a threshold in order to determine the candidate area as an area of attention (i.e. whether or not the candidate area is an area of attention).

Such an implementation may further comprise determining a natural orientation of the heads of the neighborhood, towards a game action zone located in front of said space, and the aforementioned estimated average may then be weighted by an angular difference between the head orientation of the spectator and his or her natural orientation towards the game action.

It is also possible to use an image wider than that of the neighborhood to determine this natural orientation, as in the typical illustration in FIG. 2 of a wide-field image, described below.

In one embodiment, in which the space where spectators are gathered is typically a spectator stand with several rows and several columns, the aforementioned current neighborhood may consist of spectators located:
in the same row as a candidate area as an area of attention, and at least one row above and at least one row below said same row, and
in the same column as the candidate area, and at least one column to the left and at least one column to the right of said same column.

In this case, for estimating the average, a greater weight may be assigned to spectators in the row below than to spectators in the aforementioned same row, and a lower weight to spectators in the row above than to spectators in the aforementioned same row.

Such an implementation thus satisfies the principle of taking into account the natural orientation of a spectator's head towards the game action. Indeed, a spectator in a lower row has a natural tendency to look at the game action, generally in front of him or her, and therefore his or her head is naturally oriented generally downwards. If, in contrast, the spectator's head is detected as being oriented upwards (for example, towards the upper stand), then this situation is unusual and more weight is given to such a determination in the estimation of the average.

Similarly, more weight may be assigned to spectators who are several columns away from the candidate area than to those who are only for example a single column away from the candidate area, because even though the spectators are far from the candidate area, that area is still attracting their attention.

In one embodiment, the estimation and detection of the method are repeated for a plurality of successive neighborhoods in one or more successively acquired images.

For example, the aforementioned threshold may be determined based on the averages estimated for these successive neighborhoods.

Typically, before estimating the respective head orientations of the spectators in the neighborhood, a detection of the spectators' heads may be implemented (as objects recognized by artificial intelligence for example), and from there, it is then possible to estimate the orientation of the heads thus detected. It will be understood in particular that this detection of heads is not necessarily facial recognition of a specific individual but simply a detection of an object corresponding to a human head.

This detection of spectator heads may typically be followed by a determination of the respective positions of these heads, which makes it possible to determine, for each spectator, the aforementioned straight line passing through the spectator's head and through the candidate area as an area of attention.

According to another aspect, a computer program is provided comprising instructions for implementing all or part of a method as defined herein when the program is executed by a processor. According to another aspect, a non-transitory, computer-readable storage medium is provided on which such a program is stored.

According to another aspect, a device for processing image data concerning a stand comprising spectators is provided, comprising a processing circuit for implementing the above method.

### BRIEF DESCRIPTION OF THE DRAWINGS

Other features, details and advantages will become apparent from reading the detailed description below, and from analyzing the attached drawings, in which:

FIG. 1 illustrates an example of a succession of general steps of a method of the type presented above.

FIG. 2 shows a wide-field image of a spectator stand, showing in particular a general orientation of the spectators' heads towards game action taking place in front of the stand.

FIG. 3 illustrates one possible implementation for detecting the head orientations of spectators in a stand.

FIG. 4 illustrates the head orientations of a neighborhood, towards an area of attention represented by a gray disk, while the heads of other spectators outside this neighborhood (typically at the bottom of FIG. 4) are naturally more oriented towards the game action on the field.

FIG. 5 illustrates one example of a possible neighborhood to associate with a candidate area as an area of attention.

FIG. 6 illustrates an angle normally expected between a spectator's natural head orientation towards the game action, and a current actual head orientation of that spectator.

FIG. 7 illustrates a succession of steps which are more specific than those in FIG. 1, in one particular example of an implementation of the method.

FIG. 8 schematically illustrates one possible embodiment of a device of the type presented above.

### DETAILED DESCRIPTION OF CERTAIN ILLUSTRATIVE EMBODIMENTS

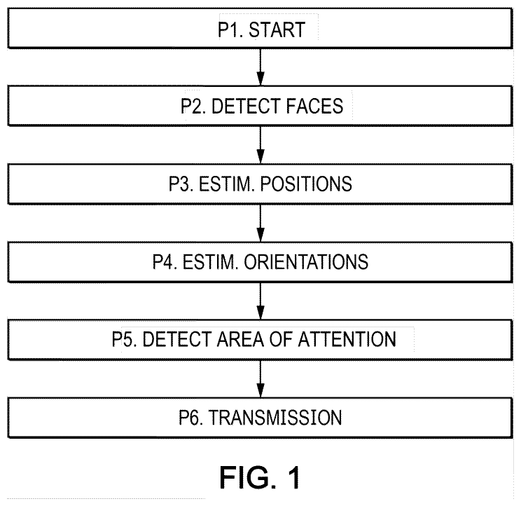

Reference is now made to FIG. 1, showing one example of a succession of general steps of a method according to one embodiment. This method proposes an automatic determination of an area of attention by spectators in a stand, using computerized data processing of images to analyze the orientation of the attention of the spectators themselves.

During a first step P1, the method is triggered by manual intervention, or automatically via a request from another system (for example a monitoring system or a television channel control center), or regularly (for example, every five minutes), or other.

The second step P2 comprises a detection of heads as objects, simply identified as being heads (or faces). This is therefore not facial recognition. Identifiers ID #i are assigned to these heads for ensemble calculations, described below.

In step P3, the respective positions POS_i of these heads are determined in order to define straight lines (or directions) towards an area of interest: a candidate in the aforementioned ensemble calculations. The positions may be determined in the 2D image captured by a camera filming the stands, for example.

However, it is also possible to determine the positions in a 3D space based on a determination of the distance between each detected object and the camera, which typically allows transitioning from a cylindrical coordinate system to an orthonormal system. This distance estimation may be implemented by making use of artificial intelligence, based simply on a frontal view. Indeed, approaches for estimating (relative) proximity can be robust when using only a single monocular view. Thus, using a single image, artificial intelligence of this type can propose a table of values corresponding to an inferred result for each pixel. This approach has the advantage of using a standard, low-cost camera, and there is no need for a stereoscopic camera or one equipped with a sensor such as LiDAR. However, cameras with optics that induce strong distortion, such as wide-angle lenses (e.g. fisheye lenses), should be avoided.

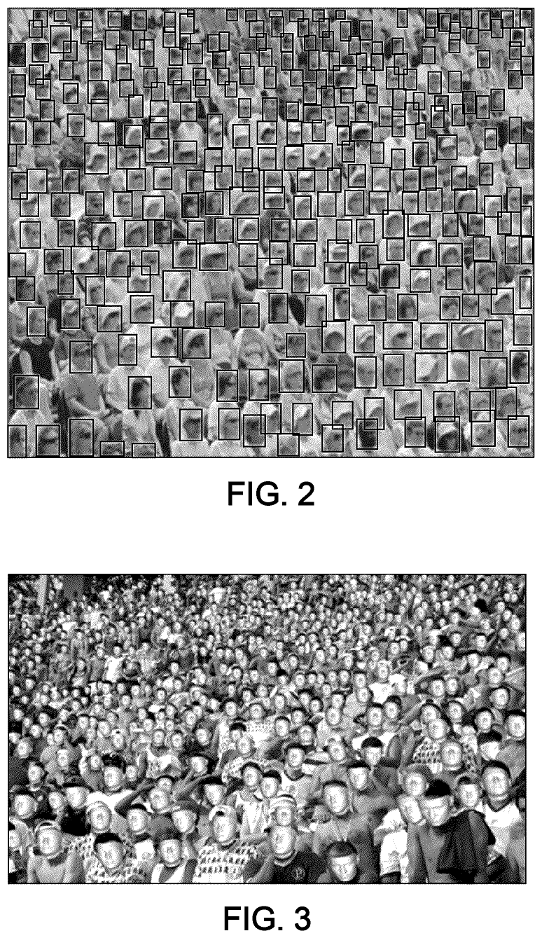

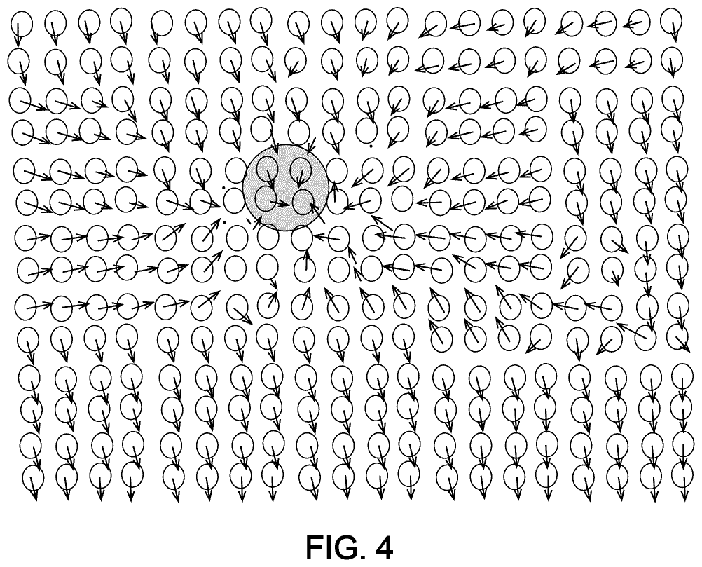

One advantage of applying such an implementation to the context of crowd tracking in a stadium is that the arrangement of people who are primarily seated and facing the main area of interest (which normally takes place in the center of the stadium) makes head detection even more efficient: there are indeed few occlusions, as shown in FIG. 2.

For example, the result of multiple detections of these objects may be a list of information, each presenting in particular a rectangle encompassing the detected occurrence, as illustrated in FIG. 2. This position data, in pixels, in the acquired image, can be transcribed into an absolute location due to knowing the geometry of the stands, the location of the fixed camera, as well as the orientation of the camera's lens if it is motorized.

The fourth step, P4, aims to determine the orientation of the attention of each spectator whose head has been detected. This step may be implemented solely within a restricted neighborhood as described below, and not encompassing an entire wide-field image, for computational savings in particular.

“Orientation of the attention” generally means a determination according to various possible approaches: orientation of the gaze, orientation of the face, or, more generally, orientation of the spectator's head.

For a large audience (a situation where the proposed processing is particularly useful), it may be advantageous to “capture” the head orientation. The term used in the literature is “head pose estimation.” Indeed, learning and inference models exist for predicting head orientation based on a single image. Most of these perform a detection of the face and facial landmarks (eyes, nose, mouth) in order to coordinate the learning. These approaches are then valid for the typical interval [−90°, +90°]. Other approaches bypass facial landmarks to rely directly on head detection (without facial landmarks alone) and then offer an estimate within a much wider range. A difficulty then arises, linked to discontinuity in the angle of rotation +180° to −180°. Machine learning models have great difficulty managing discontinuities, but recent research proposes radically changing the mode of representation. Indeed, Euler angles have the dual advantage of conciseness and ease of interpretation. Conversely, a general rotation matrix does not have these advantages but provides continuity, which is useful for machine learning algorithms. Without decreasing the generality here, orthonormal matrices may be used: the last column is deduced from the first two so that there are (only) six parameters to determine. Detections are then possible even for people viewed from behind.

However, in one particular embodiment, capturing the orientation of attention by detecting facial landmarks may also be a simple solution, adapted to the application envisaged here. FIG. 3 illustrates such a detection.

The fifth step P5 aims to determine whether a particular area of attention is emerging. This requires ensemble processing of the information provided by each spectator (location and axis of attention).

In particular, the aim is to determine whether a small area of the crowd (or near the crowd) is the focus of multiple attentions from nearby locations, typically within a given neighborhood. For example, a threshold of one hundred people (all with their heads oriented toward the area), among the two hundred nearest neighbors of this area, must be reached for the aforementioned area to be considered an area of interest.

For illustrative purposes, described below is one specific method for determining that a small area is the focus of attention of people located nearby.

It is assumed that initially everyone is positioned according to a grid corresponding to the layout of the seats in a stand.

Spatial processing for 2D matrices may be used, particularly in computer vision, for example using a convolution and cross-correlation algorithm.

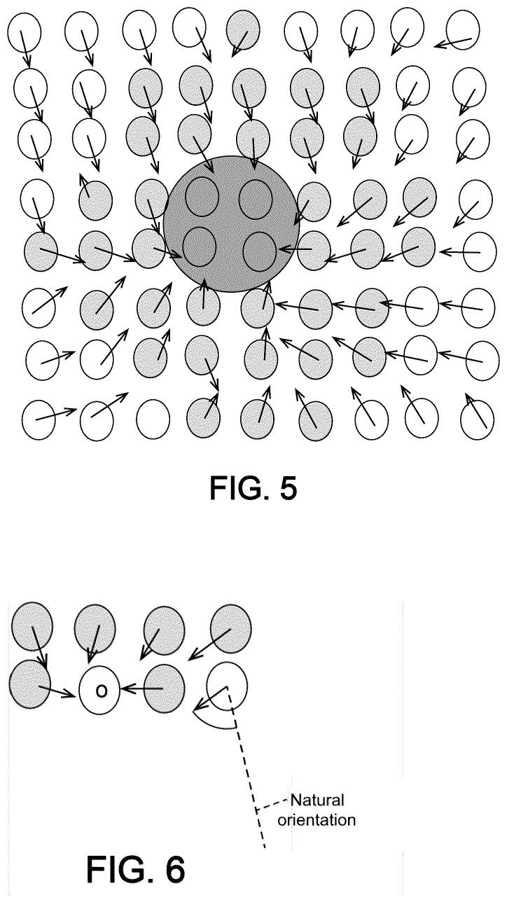

Hereinafter, “I” refers to a 2D matrix, in which the value for each group of pixels is an angle alpha, in radians, of the orientation of the attention of the person located at the location. Furthermore, the entire area to be monitored may be scanned in small areas in succession. The diagram in FIG. 5 illustrates the use of scanning in a disk; this may also be a rectangle if the area to be monitored lends itself to a grid. In all cases, the shape of the scan should be of moderate size because the desire is to capture the orientation of the attention of people located near the area being searched.

Then, “O” denotes a basic scan area and “V(O)” a neighborhood of people around this basic area (for example, all pixels located within a rectangle or a disk centered at O). In the diagram in FIG. 5, these are the people who appear as gray.

For any point M in neighborhood V(O), we define a unitary cross-correlation coefficient c(O,M)=−cos(OM,alpha).

Thus, for any area O to be scanned, an average neighborhood ensemble coefficient is defined: c(O)=SUM (M in V(O)) [−cos(OM, alpha (M)]/card (V(O).

The interpretation is as follows: for a given point O, when such a coefficient has a value close to 1 this means that almost all the neighbors are looking at it.

Admittedly, as is, such processing is expensive in terms of the number of calculations, particularly the angle correlation operations, but the various techniques for quantification and parallelization of the processing nevertheless enable a real-time approach.

Very moderate precision is sufficient, and a true cosine calculation can be avoided in 64-bit floating-point values. Ultimately, a simple table of values with, for example, only 100 intervals is largely sufficient. Finally, a precision to 106 is also sufficient, so natural numbers can easily be manipulated.

Finally, this 2D matrix of natural numbers (or image) is conducive to a massively parallel processing architecture using computer vision technologies.

In the case of bleachers, the seats are typically oriented toward the game action. A user's attention is naturally directed in this direction. Conversely, the more a user “is looking back,” the more valuable this information is for the purpose of detecting atypical situations.

Thus, the unitary cross-correlation coefficient may be weighted by a coefficient of deviation from the nominal axis for this user. This is illustrated in FIG. 6, with an interval [0,1], using for example: (1−cos(alpha,axis))/2. Here again, quantification with only 100 values makes it possible to limit this to integer operations.

The nominal axis for a given spectator can be simple to determine. It may naturally be the axis of the orientation of their seat. In one simple implementation, it may be decided to give more weight to spectators in the neighborhood who are seated in seats that are below a presumed area of interest (spectators below the circle in FIG. 5) than to those who are seated in seats located above this area, and to assign an intermediate weight to spectators seated in “the same row” as the area of interest.

However, the area of interest may be outside the stands (for example, in one of the access doors to the stands). Indeed, the area of interest may not necessarily coincide exactly with the area where the spectators are seated, and may extend beyond it (particularly at the access doors, for example), while noting that there should be spectators not too far from the area of interest since they are the information vectors.

Thus, alternatively, the nominal axis may be determined more generally by the area of attention for the event. This area may evolve over time: for example, it could be the location of the ball in a soccer match. Particularly in the world of sports, there are many methods of video analysis that allow the area of interest of the activity to be determined in real time. Typically, an average of the head orientations in a wide-field image, as illustrated in FIG. 2, may also be used to determine a nominal axis of the normal head orientation towards the game action. Also, at the precise moment of calculating the weighting coefficient for a given spectator, it is possible to determine the angle difference between the spectator's axis of attention and the nominal axis of the action on the field.

In the next general step, P6 of FIG. 1, a signal containing the coordinates of an area of attention thus detected may be transmitted to a third-party system, for example in order to generate an alert at a monitoring system for incident detection. This signal may also be transmitted to a control room (for example, a control room in a truck positioned near the stadium) to generate an audiovisual stream intended for broadcast by a television channel, from the streams captured by different cameras. In such an implementation, the signal generated in step P6 may be interpreted by a control device capable of controlling a camera to zoom into the area of attention, and thus to film a scene that a significant number of spectators are watching (for example, a person known to the general public, a spectator who is dancing, etc.).

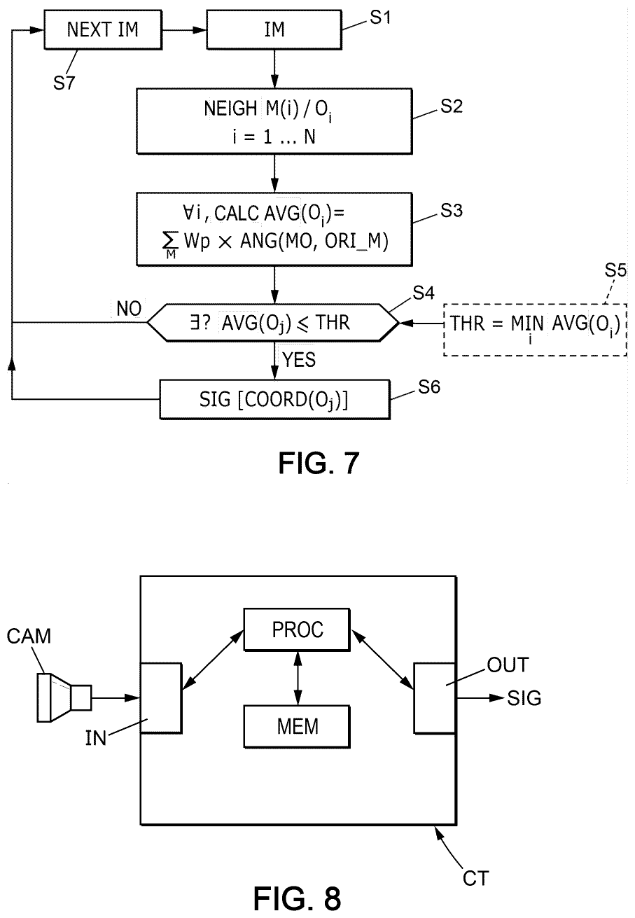

FIG. 7 illustrates one possible embodiment with an alternative implementation of step P5 above, for determining whether a candidate area O is an area of attention (or at least a possible area of interest). In step S1, a current image IM is considered, for example a wide-field image. In step S2, respective neighborhoods of possible candidate areas O are defined. Each candidate area O may correspond to a group of pixels extending over a few rows and columns of the image IM, and the dimensions of this area may correspond to the apparent dimensions of a seat in the image IM, for example. Thus, the image IM is gridded, and each element of the grid may have the dimensions of a seat and in the following will be considered a candidate area O as a possible area of attention.

In step S2, a neighborhood NEIGH M (i) is assigned to each candidate area O (i). A neighborhood may extend, for example, to two rows (of seats) above and below the candidate area O and to three columns (of seats) to the left and to the right of the area O. The number of neighbors M in a neighborhood may thus be about thirty points M (5×7−1).

In step S3, we first calculate, for a candidate area O as an area of attention, each angle ANG between:
the head orientation ORI_M of a neighbor M, and
the line passing through this neighbor M and the candidate area O.

A metric for angle measurement (e.g. its sine or tangent, or directly the value of the angle in radians) is used to calculate the sum of these angles (in absolute values of these angles) over all neighbors M of the candidate area O, and, from there, an angular average AVG (O) may be calculated as a possible ensemble metric over the neighborhood of a candidate area O. The angular average AVG (O) may be weighted according to the relative positions of each neighbor M in relation to the candidate area O. For example, more weight may be assigned to the angles formed by neighbors sitting in the lower tiers, with an even stronger weight for the second row below the candidate area O. Similarly, the weight Wp may be increasing according to the number of columns between the candidate area O and the position of a neighbor M.

Once the average (thus weighted) has been calculated for a candidate area O, this average is compared to a threshold in step S4, and if this average is lower than the threshold THR, then the area Oj having this average may be an area of attention the algorithm is looking for. The aforementioned threshold may be configurable. It may be, for example, the smallest average determined for all successive candidate areas O in the given wide-angle image IM. Thus, for example, in step S5, the averages over their neighborhood are successively calculated for each candidate area O, and the one with the smallest average is selected, for example for controlling a camera to zoom in on that area as a possible area of attention.

However, this step S5 is optional (and therefore illustrated by dotted lines). Alternatively, it is possible to determine a threshold value THR from feedback from previous experiences, and independently of the determination of a minimum average in the image. Thus, if a candidate area is identified for which the average is below this threshold THR, then step S6 is triggered (YES arrow exiting test S4). Otherwise (NO arrow exiting S4), the processing is repeated on another image IM.

Step S6 corresponds to step P6 of FIG. 1, namely the transmission of a signal comprising coordinates of the area of attention (for which the average has been determined to be below a threshold THR).

Steps S1 to S5 (and possibly S6) may then be reproduced on a new general image captured in step S7 (NEXT IM), either with another camera position to monitor other stands of the stadium for example, or with the same camera position and typically at a subsequent time.

All or part of these steps may be implemented by a device as illustrated in FIG. 8, the device comprising a processing circuit CT equipped with:
an input interface IN for receiving image data captured by a camera CAM, and possibly data concerning the current settings of the camera (for example if it is a mobile camera),
a memory MEM, in particular storing instruction data of a computer program for the above implementation (and possibly, for example, data concerning the estimated averages for different candidate areas as areas of attention for the implementation of step S5 typically),
a processor PROC capable of accessing the memory MEM in order to read and execute the instructions of the aforementioned computer program in order to implement the method, the processor further receiving the image data acquired via the input interface IN, on the basis of which one or more areas of attention can be detected as described above with reference to one and/or the other of FIGS. 1 and 7,
and an output interface OUT capable of delivering in particular the signal SIG comprising data concerning the area of attention detected by the implementation of the method, for example geographic coordinate data for this area of attention (determined based on the camera settings, for example).

This signal may be shaped, in order to feed it to a monitoring system and/or an additional camera at the stadium capable of zooming into an area of attention for which the coordinates have been transmitted and interpreted by the additional camera.

### INDUSTRIAL APPLICATION

These technical solutions may be applied in particular to ensuring spectator safety, in particular for events having global media coverage, such as soccer cup matches or the Olympic Games.

This disclosure is not limited to the examples described above, which are provided solely as examples, but encompasses all variants conceivable to those skilled in the art within the context of the desired protection.

Knowledge of the geometry of the stands and of the current settings of the capturing camera may be used to determine the absolute location of the detected object. In one particular embodiment, a stereoscopic camera may be used to provide location information more directly.

Instead of using one or more fixed cameras, the method may also be applied to mobile cameras, whether aerial drones or devices which move along a cable. It is then appropriate to equip the capture system with a location determination device, for example GPS or simply linearly along the supporting cable, which allows calculating the changes in reference point to be made in order to re-establish a situation of the type described above.

The method may be applied in the case of an audience having seat positions. However, this involves tracking people where there is relatively little moving around. More generally, the method may then be applied to any type of static crowd or audience, at least during the calculation of a candidate area as an area of interest.

What is claimed is:

1. A method of processing image data concerning a space where spectators are gathered, the method comprising:
estimating, in a current neighborhood of spectators in the image, the respective head orientations of spectators in the neighborhood; and
detecting, at least on the basis of the estimated head orientations, whether the heads are oriented towards an area in the space, in order to generate, if appropriate, a signal comprising data concerning the area as an area of attention for spectators in the space.

2. The method according to claim 1, wherein the signal comprises geographic coordinate data for the area of attention.

3. The method according to claim 2, wherein the image is captured by a mobile camera and the geographic coordinates are deduced from current settings of the mobile camera.

4. The method according to claim 1, wherein the signal to zoom into the area of attention is transmitted to a monitoring camera.

5. The method according to claim 1, wherein, for each spectator in the neighborhood associated with an area that is a candidate area as an area of attention, an angular deviation is estimated between:
a straight line passing through the spectator's head and the candidate area, and
a head orientation of the spectator,
where the more the spectator's head is oriented towards the candidate area, the smaller the absolute value of the angular deviation.

6. The method according to claim 5, wherein an average representative of the angular deviations is estimated over all spectators in the neighborhood, for the candidate area, and
the estimated average is compared to a threshold in order to determine the candidate area as an area of attention.

7. The method according to claim 6, which further comprises determining a natural orientation of the heads of the neighborhood towards a game action zone located in front of the space,
the estimated average being weighted by an angular difference between the spectator's head orientation and the natural orientation.

8. The method according to claim 1, wherein the space where spectators are gathered is a stand with several rows and several columns,
and wherein the current neighborhood consists of spectators located:
in the same row as a candidate area as an area of attention, and at least one row above and at least one row below the same row, and
in the same column as the candidate area, and at least one column to the left and at least one column to the right of the same column.

9. The method according to claim 8, wherein, for each spectator in the neighborhood associated with an area that is a candidate area as an area of attention, an angular deviation is estimated between:
a straight line passing through the spectator's head and the candidate area, and
a head orientation of the spectator,
where the more the spectator's head is oriented towards the candidate area, the smaller the absolute value of the angular deviation,
wherein an average representative of the angular deviations is estimated over all spectators in the neighborhood, for the candidate area, and
the estimated average is compared to a threshold in order to determine the candidate area as an area of attention,
and wherein, for estimating the average, a greater weight is assigned to the spectators in the row below than to the spectators in the same row, and a lower weight is assigned to the spectators in the row above than to the spectators in the same row.

10. The method according to claim 1, wherein the estimation and detection are repeated for a plurality of successive neighborhoods in one or more successively acquired images.

11. The method according to claim 10, wherein, for each spectator in the neighborhood associated with an area that is a candidate area as an area of attention, an angular deviation is estimated between:
a straight line passing through the spectator's head and the candidate area, and
a head orientation of the spectator,
where the more the spectator's head is oriented towards the candidate area, the smaller the absolute value of the angular deviation,
wherein an average representative of the angular deviations is estimated over all spectators in the neighborhood, for the candidate area, and
the estimated average is compared to a threshold in order to determine the candidate area as an area of attention,
and wherein the threshold is determined based on the averages estimated for the successive neighborhoods.

12. The method according to claim 1, wherein the estimation of the respective head orientations of the spectators in the neighborhood is preceded by a detection of the spectators' heads.

13. The method according to claim 12, wherein the detection of the spectators' heads is followed by a determination of the respective positions of the heads, in order to determine, for each spectator, a straight line passing through the spectator's head and a candidate area as an area of attention.

14. A non-transitory computer-readable medium storing instructions that, when executed by a processor, cause the processor to perform the method according to claim 1.

15. A device for processing image data concerning a space where spectators are gathered, comprising a processing circuit for implementing the method according to claim 1.
